(19) United States
(12) Patent Application Publication
(10) Pub. No.: US 2010/0228613 A1
(43) Pub. Date: Sep. 9, 2010

(54) Systems and Methods for Interactively Rewarding Users of an Entertainment System

(76) Inventors: Andrew T. Anderson, Los Gatos, CA (US); Michael A. Catalano, Los Gatos, CA (US); Benjamin Silva, III, Fremont, CA (US); Mitchell Louis Berman, Menlo Park, CA (US); Matt McKee, Rocklin, CA (US)

Correspondence Address: CARR & FERRELL LLP, 2200 GENG ROAD, PALO ALTO, CA, 94303, US

(21) Appl. No.: 12/396,866

(22) Filed: Mar. 3, 2009

(51) Int. Cl. G06Q 30/00; G06F 17/00; G06Q 50/00

(52) U.S. Cl. 705/14.13; 700/94

(57) ABSTRACT

A user is rewarded for actions performed within an entertainment system. Digital content is provided to a client device over a network. Data is then received from the client device over the network. The received data represents an input from a user of the client device in response to the digital content provided to the client device. A value associated with the input from the user is determined. An account balance associated with the user is adjusted by a quantity of credit tokens. The quantity of tokens is determined by the value associated with the input from the user.

### BACKGROUND

1. Field of Invention

The present invention relates generally to entertainment systems, and more particularly to interactively rewarding users of an entertainment system.

2. Description of Related Art

Broadcast television and radio entertainment has traditionally been supported through paid advertisements. Consumers would be able to view and/or listen to entertainment programs provided by the broadcasters free of charge, because the costs of producing and broadcasting the entertainment programs would be paid for through the paid advertisements. Advertisers would be willing to pay to have their paid advertisements broadcast during the entertainment programs because the advertisements would be viewed and/or listened to by those who were viewing and/or listening to the entertainment programs.

Upon the advent of cable television, a new category of subscription-based entertainment emerged. In subscription-based entertainment, consumers paid a periodic fee (e.g., monthly) to receive entertainment programs without commercials throughout the period for which the consumers paid through the fee. Premium channels (e.g., movie channels) such as HBO (Home Box Office) were among the first services to provide commercial-free programming via the subscription-based entertainment model. More recently, a variant of the subscription-based entertainment model known as pay-per-view emerged in which consumers could pay a single fee for a viewing of a single entertainment program without commercials. Pay-per-view cable television was among the first primitive applications of interactive cable television.

With the advent of video cassette recorders, consumers began to time-shift their viewing of television by recording an entertainment program when it was broadcast, and then watching the entertainment program at a later time. The ability to time-shift the viewing of an entertainment program carried with it the ability to fast-forward through advertisements without watching the advertisements. This had the potential to impact the value of a paid advertisement during an entertainment program, but in fact had little impact because a consumer would need to wait until the program was completely over to view the program, and because the consumer would typically still see the video of the advertisement while the advertisement was being fast-forwarded. A consumer may not have the patience to wait until a program was completely over to begin viewing the program. An artfully presented advertisement may catch a consumer's eye while fast-forwarding through the advertisement, enticing the consumer to stop and watch the advertisement before continuing on with the program.

With the advent of digital video recorders (e.g., ReplayTV and TIVO), consumers now had the option of beginning to watch a recorded program while the program was still being recorded. Plus, digital video recorders now offered the ability to automatically skip commercials without requiring any action by the consumer, as well as a single button to instantly skip over 30 second increments of the entertainment program. A typical paid advertisement is 30 seconds long. As a result, consumers now have the ability to begin watching an entertainment program shortly after the program begins to be broadcast, and not see any portion of any paid advertisement broadcast during the entertainment program. For example, a consumer may begin watching a typical one hour program just fifteen minutes after it begins, skip all paid advertisements broadcast throughout the program, and finish watching the program when the broadcast of the program ends. The consumer may then be able to discuss the highlights of the program with friends immediately after the program ends, even with friends who had begun to watch the program when it began to be broadcast.

With the rising popularity and pervasiveness of digital video recorders, the value of the traditional paid advertisement model for free broadcast television, as well as non-premium cable television, is threatened more than ever before. Consumers are no longer required to watch paid advertisements in order to view entertainment programs supported by paid advertisements, and paid advertisers can no longer be guaranteed that consumers will view their paid advertisements. There is a reduced incentive for consumers to watch paid advertisements during entertainment programs, and for advertisers to pay to advertise during the entertainment programs.

### SUMMARY OF THE INVENTION

A computer-implemented method for rewarding a user of an entertainment system is disclosed. Digital content is provided to a client device over a network. Data is then received from the client device over the network. The received data represents an input from a user of the client device in response to the digital content provided to the client device. A value associated with the input from the user is determined. An account balance associated with the user is adjusted by a quantity of credit tokens. The quantity of tokens is determined by the value associated with the input from the user.

In some embodiments, a method for rewarding a user may provide digital content to a client device over a network by a server. Data may then be received from the client device over the network by the server. The received data may represent an input from a user of the client device in response to the digital content provided to the client device. The server may determine a value associated with the input from the user. An account balance associated with the user may be adjusted by a quantity of credit tokens. The quantity of credit tokens may be determined by the value associated with the input from the user.

A method for rewarding a user of an entertainment system may provide electronic media by a server to a user client device over a network. The server may receive user data from the client device, wherein the user data is associated with a user action related to the electronic media provided to the client device. The server may then determine a reward for the user. The reward may be determined at least in part from the user data. An account balance associated with the user may be adjusted based on the reward.

### BRIEF DESCRIPTION OF THE DRAWINGS

FIG. 1 illustrates an exemplary entertainment system environment.

FIG. 2 illustrates an exemplary method for rewarding a user of an entertainment system using credit tokens.

FIG. 3 illustrates an exemplary method for rewarding a user of an entertainment system using digital media.

FIG. 4 illustrates an exemplary method for determining reward values associated with advertisements.

FIG. 5 illustrates an exemplary client device.

### DETAILED DESCRIPTION OF THE INVENTION

An entertainment system operator may offer a user of the entertainment system rewards for viewing advertisements. The rewards may be an incentive to the user to proactively view an advertisement, and may be effective to increase a number of consumers who actually view paid advertisements. The user may be rewarded with credit tokens which may be exchangeable for digital content, products, or services. The user may have a credit tokens account with the entertainment system. The credit tokens account may include credit tokens which the user may earn by performing activities which an operator of the entertainment system may wish to reward. The credit tokens may have properties akin to rewards and incentive programs such as frequent flyer miles programs. The user of the entertainment system may select which advertisements to watch and when to watch the advertisements in order to build up a quantity of credit tokens in an account. Then, the user may spend the credit tokens from the user's account to watch an entertainment program free of interruptions with commercial advertisements. The credit tokens may also be transferrable to one or more other users or entities. The user may also purchase the credit tokens with legal tender such as U.S. dollars or financial credit denominated in legal tender. Likewise, the user may sell the credit tokens for legal tender such as U.S. dollars or financial credit denominated in legal tender.

Credit tokens may be utilized in conjunction with commercial marketing campaigns involving promotions, advertisements, contests, and/or social networking. In an exemplary field trial marketing campaign, a user may be rewarded with credit tokens for engaging in activities promoted by the marketing campaign, such as purchasing promoted products or viewing promoted media. The field trial marketing campaign may be directed toward testing a market, collecting market data to present to advertisers, determine a value or price for a product or service, or other marketing related goals. An entertainment system operator may deploy the field trial marketing campaign and adjust campaign parameters such as credit tokens earning rate, credit tokens conversion ratio, pool of available credit tokens associated with the campaign, and/or number of users that may participate in the field trial marketing campaign.

In some embodiments, a limited quantity of credit tokens having particular properties may be allocated at a given time for a particular marketing campaign. For example, all credit tokens associated with a particular marketing campaign may share properties such as value, how they may be earned, how they may be exchanged, or how long they may be valid. In some embodiments, when the limited quantity of credit tokens reaches a threshold level of being all spent, additional credit tokens may be allocated, or the spent credit tokens may be placed back in circulation among users of the entertainment system.

In an exemplary customer community campaign, a user may be rewarded with credit tokens for engaging in volunteer and/or charitable activities. These activities may include donating credit tokens and/or legal tender to charitable organizations, posting to sponsored blogs, participating in sponsored contests, and engaging in sponsored social networking activities.

In an exemplary advertisement pool campaign, users may be rewarded with credit tokens for viewing advertisements, interacting with interactive advertisements, or purchasing products or services associated with the campaign. In the exemplary advertisement pool campaign, the credit tokens are withdrawn from a common pool of campaign credit tokens independent of which campaign advertisements are viewed and who the providers of those campaign advertisements are. The pool of campaign credit tokens are funded by one or more providers of the advertisements participating in the campaign. In some embodiments, different providers of participating advertisements may fund the pool of campaign credit tokens by different quantities of credit tokens and/or different amounts of legal tender. For example, a first provider of an advertisement may desire preferential positioning of its advertisement, and therefore fund the pool of campaign credit tokens with a higher than average quantity of credit tokens. A second provider of an advertisement may desire a lower cost of participating in the program, and therefore accept a less prominent positioning of its advertisement in exchange for being allowed to participate by funding the pool of campaign credit tokens at a lower than average quantity of credit tokens.

In an exemplary sponsored campaign, a sponsor may reward a user with credit tokens for participating in sponsored activities. The sponsored activities may include promotions, specials, and events. In one example, a sponsor such as an entertainment system operator may sponsor a campaign in which a user of the entertainment system is rewarded with credit tokens when the user self-installs software or hardware associated with the campaign rather than having the entertainment system operator perform the installation. In this way, the entertainment system operator may save installation costs by not needing to send a person to perform the installation at the user's location, and may reward the user by providing the user with a quantity of credit tokens.

In an exemplary super rewards campaign, a user of the entertainment system who is also a member of a sponsor's third party network may be rewarded for incentivized activities with either credit tokens, third party network rewards such as frequent flyer miles or credit card rewards points, or a combination thereof. In an embodiment, credit tokens may be exchanged for the third party network rewards and vice versa.

In an exemplary brand campaign, a user of the entertainment system may be rewarded by a sponsor promoting a particular brand for incentivized activities with branded credit tokens. The branded credit tokens may have usage restrictions and capabilities specific to the brand campaign. In an embodiment, the branded credit tokens may be exchanged for products, services, or digital content only available through the use of the branded credit tokens. An embodiment of the exemplary brand campaign may also include cross promotions between the entertainment system operator and the brand sponsor or third parties, or any combination thereof. The branded credit tokens may also be exchangeable for third party network rewards and vice versa.

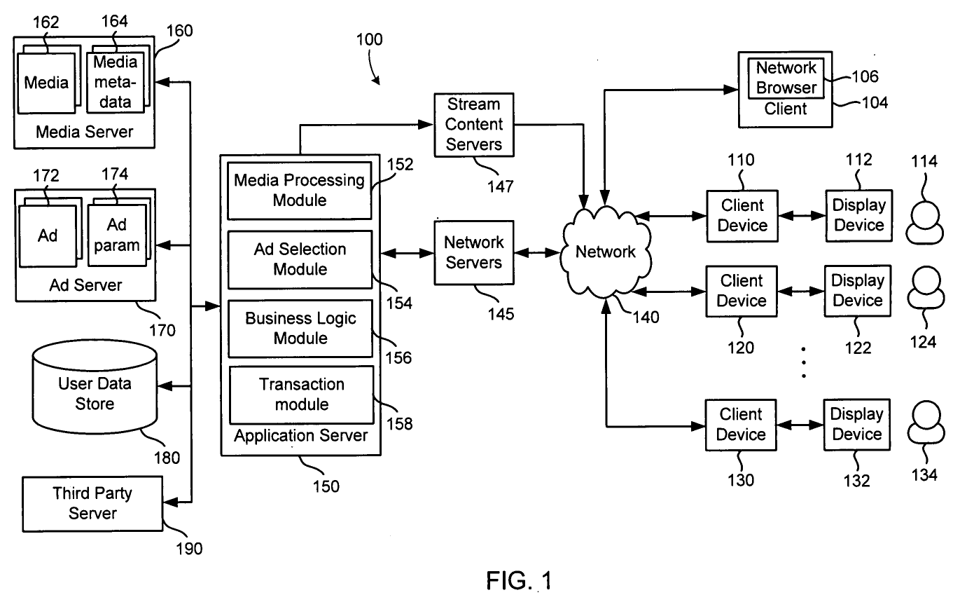

FIG. 1 is a block diagram of an exemplary environment for an entertainment system which provides a media service (e.g., an entertainment service) to a user. The entertainment system of FIG. 1 includes a system of servers in communication with a system of client devices over a network. Client devices 110, 120 and 130 communicate with display devices 112, 122 and 132, respectively. Users 114, 124 and 134 are associated with each display device and client device combination, respectively. For example, a user 114 may provide input to client device 110 to retrieve and playback video content through display device 112. In some embodiments, the media service discussed herein is implemented by application server 150 and network server 145. In some embodiments, the system providing media service may also include any of servers 147, 160, 170, 180, and 190.

Client devices 110, 120, and 130 and client 104 are coupled to network 140. In some embodiments, each of client devices 110, 120, and 130 may be implemented as a set-top box which provides content through a viewer user interface. An exemplary set-top box is disclosed in U.S. patent application Ser. No. 12/360,007, entitled “Set-Top Box,” filed on Jan. 26, 2009, the disclosure of which is incorporated herein by reference. Other devices may embed the technology described herein directly, including but not limited to television sets, mobile devices, gaming consoles, watches, phones, and digital cameras. A client device may also include a computing processor, a personal computer, a digital video recorder (DVR), a videocassette recorder (VCR), a digital versatile disc (DVD) recorder, a compact disc (CD) recorder, and/or the like. The client devices may interact with other client devices or servers 145, 147, 150, 160, 170, 180 and 190 communicatively coupled with the client device over a network. The client devices 110, 120, and/or 130 may facilitate interaction between their respective users as part of a social network.

Client 104, which may include a personal computer, is coupled to network 140 and may include network browser 106. Network browser 106 may request, receive and provide network content such as a web page. For example, a user may access a media service provided over network 140 through network browser application 106. Client 104 may perform any function described herein as being performed by client device 110, 120, or 130, and vice versa.

The network 140 may include one or more wired or wireless computer networks, such as a Wide Area Network, a Local Area Network, an Ethernet network, a Wi-Fi network, a cable television network, a landline telephone network, a cellular telephone network, a digital subscriber line (DSL) network, a Wi-Max network, an asynchronous transfer mode (ATM) network, and the Internet. The network 140 may include one or more such computer networks which communicatively interface with one another. One or more of each such computer network may provide one-way communication paths, and one or more other of each such computer networks may provide two-way communication paths. Network 140 may facilitate communication between network server 145, client 104 and client devices 110, 120, and 130, as well as servers 147, 150, 160, 170, 180, and 190 (complete network not illustrated in FIG. 1).

Network server 145 may include one or more servers and communicates with application server 150 and network 140. Network server 145 may be implemented as a web server that operates as an intermediary server between application server 150 and network 140. For example, network server 145 may be a web server or application web server that receives requests from client 104 and client devices 110, 120 and 130, processes and forwards the requests to application server 150, and sends a response generated by application server 150 to the requesting client or client device.

Application server 150 communicates with network server 145, may include one or more servers, and includes logic which implements the media service of the present technology. Application server 150 may include media processing module 152, ad selection module 154, business logic module 156 and transaction module 158. Each of the modules 152, 154, 156, and 158 may be implemented on a different application server or backend server, such as servers 160, 170, 180, and 190. Other modules and logic may be incorporated on application server 150 in addition to those illustrated in FIG. 1.

Media processing module 152 may receive, encode, and transmit video, audio, images and other media to client 104 and client devices 110, 120, and 130 through network server 145. The media may be transmitted as a complete file, a streaming data such as streaming video, or in some other format. Media processing module 152 may incorporate selected advertisements received from or identified by ad selection module 154 within video media and transmit the video media with the incorporated ads.

Ad selection module 154 may access advertisement media and advertisement parameters from ad server 170. The ad parameters specify how ads may be incorporated into a particular media file by media processing module 152. The parameters may indicate a user gender, geographic location, income level, marriage status, or other user demographic data, as well as user viewing behavior, purchase behavior, and other user data, or the ad may be selected directly by the user. The ad parameters may also specify content categories, brand adjacency, frequency requirements, cost information, and other display rules for providing the ad to a user.

Business logic module 156 may handle various business logic and processing rules associated with the media service. For example, business logic module 156 may handle user loyalty and reward programs which reward a user for certain viewing behavior and interaction with advertisements. Business logic module 156 may also retrieve and manage user data contained in user data store 180 and determine revenue distribution among different participants in a media service ecosystem, such as users, advertisers, content providers, merchants, network service provider companies (cable companies, power companies, telephone companies, and so forth), and other groups.

Transaction module 158 may facilitate commerce transactions between a client device and third party server 190. Facilitating a purchase transaction allows a user to purchase goods or service associated with an advertisement through the media service.

Application server 150 may transmit content through stream content servers 147. In some embodiments, stream content servers 147 may include one or more servers configured to stream content to several client devices. For example, stream content servers 147 may include a host stream device which receives media and advertising content. The host stream device may provide content to one or more streaming servers which establish connections with a client device and stream media content, including requested and recommended media as well as advertisements, to the client.

Application server 150 may communicate with media server 160, ad server 170, user data store 180, and third party server 190. Media server 160 may store media 162 and related information, including metadata 164 for stored media, which may be retrieved by application server 150. Media 162 may comprise movies, TV episodes, offers, and other video, as well as audio and image media, interactive media and application services such as two-way Voice Over Internet Protocol (VOIP) telephony, two-way video and other interactive applications. Media metadata 164 may include information associated with each piece of media or an offer, such as a media category (i.e., sports, documentary, family, and so forth), media length, potential breaks within the media for inserting ads, cost of playback for media, and other data associated with the media.

In some embodiments, application server 150 may also include an operational support system (OSS) configured to provide interactive entertainment over the network 140 to a user of the client device 110, 120, or 130. In addition, the application server 150 may include a business support system (BSS) to manage business transactions relating to the interactive entertainment provided over the network 140. The functions of the OSS and the BSS may be distributed across one or more computing servers coupled with or included within the application server 150.

The BSS may manage accounting of credit tokens, including accounts in which credit tokens earned by users are transferred into (e.g., deposited or earned), held (e.g., banked), and transferred out of (e.g., withdrawn or spent). The BSS may provide numerous accounting and reporting functions relating to the credit tokens in an account. For example, the BSS may track transactions and provide a statement to a user detailing transactions involving credit tokens in the user's account over a specified period of time (e.g., monthly, quarterly, or annually). The statement of transactions may include account balances as well as identify each transaction by a transaction identifier (e.g., I.D.), a date, a time of day, a description of the transaction, an amount of credit tokens, and a type of credit tokens involved. The BSS may also provide statistics regarding a user's account of credit tokens, including a ranking compared to the user's peers, entertainment system service level, and/or a level of credit tokens achievement. The BSS may also enable a user of a credit tokens account to dispute a transaction involving the credit tokens.

The BSS may manage a user's access to account information, including assigning and authenticating a userid and password, storing and updating an email address, a phone number, a physical address, and other personal information associated with the user. The BSS may also manage a legal tender account associated with the user. In some embodiments, the user's legal tender account and reward credit tokens account may be combined or integrated together for easy reference, cross-reference, analysis, and/or reporting. The BSS may also track a user's lists of family members, buddies, friends, groups, favorite charities, and other relationships with other users and/or third parties. The BSS may provide comparative analyses to a user in which the user's account history is compared with other users according to measurable factors such as demographics, geographic information, groups, buddies, credit tokens earning categories, credit tokens spending categories, trends, etc. In various embodiments, the other user information may be aggregated and reported as a group or individually.

The OSS may control the rules and policies by which credit tokens are earned and exchanged by a user of the client device 110, 120, or 130. The OSS may control the operation of programs involving the rewards. A user's preferences associated with the rewards may be stored by the OSS. In addition, the OSS may provide a social networking functionality, enabling a user to compare the user's rewards earnings with the user's peers and friends. A variety of earnings levels and virtual trophies for earning credit tokens may be bestowed upon a user and presented in such as way that user's peers may view the virtual trophies. In this way, the OSS may enable a user to gain status among the user's entertainment system peers for the user's entertainment system activities relating to the credit tokens.

A media server 160 may communicatively couple with the application server 150 and/or the client device 110, 120, or 130 via the network 140 to provide digital content such as entertainment programs and advertisements. Media server 160 may include one or more computing servers configured to transmit audio/video media such as entertainment programs and advertisements over the network 140. The media server 160 may be associated with a television, movie, or audio recording studio. In addition, a third party server 190 may communicatively couple with the application server 150, the client device 110, 120, or 130, and/or the media server 160 via the network 140.

Ad server 170 may communicate with application server 150 and may include one or more advertisements 172 as well as advertisement parameters 174 associated with each ad. Advertisements 172 may be associated with a company, product, service or some other topic of potential interest for a user. The ad parameters indicate to whom a particular ad should or is required to be provided to, as well as cost information, timing information and other ad requirements. Ad parameters may be configured for an advertisement by an advertiser with preferred and required parameters for matching an ad to a combination of a user data (including user demographic data), media content, and time.

User data store 180 may communicate with application server 150 and include data for users having an account with the media service. The user data may include user demographic data, user playback data, user purchase data, and other data associated with a user of the media service.

Third party server 190 handles purchases requested by a user through client device 110, 120, or 130. Third party server 190 may be associated with an e-commerce service, a particular service or product provider, or some other organization. Third party server 190 may include one or more computing servers configured to provide services or products via interactions with the client device 110, application server 150, and/or media server 160. The third party server 190 may be associated with a financial institution such as a bank, credit card services provider, merchant of physical goods, merchant of digital media, computing and/or communications services provider, etc. There may be one or more different third party servers 190 communicatively coupled with the network 140.

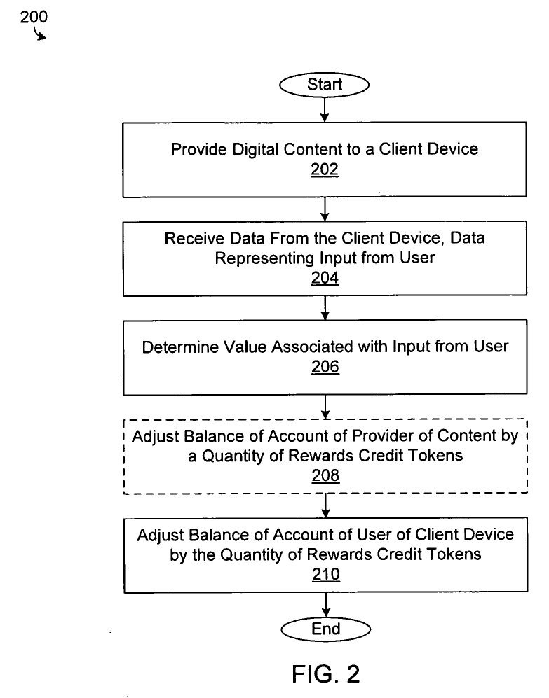

FIG. 2 illustrates an exemplary method 200 for rewarding a user of an entertainment system using credit tokens. The method may be performed by hardware and software contained in application server 150, network server 145, and optionally servers 147, 160, 170, 180 and 190. The user may use a client device such as the client device 110 to interact with the entertainment system by communicating with a server such as the application server 150 over a network such as the network 140.

In step 202, digital content is provided to a client device such as the client device 110. The digital content may be provided by the application server 150, the media server 160, or the ad server 170 via network 140. The digital content may include an entertainment program, an advertisement, a list of available entertainment programs from which the user may choose, or other data.

In step 204, data is received from the client device by application server 150. The data may represent input from the user, user behavior data, or other data. For example, the data may include a representation of the user pressing a “buy now” or other button on a remote control coupled with the client device, selecting an option from a menu of the client device, etc.

In step 206, a value of the input from the user represented in step 204 is determined. The value may be determined according to method 400 described in more detail below. The value may be denominated in terms of legal tender such as U.S. dollars or in credit tokens. The value may be determined to reward the user for providing the input.

In optional step 208, a balance of an account associated with a provider of the digital content may be adjusted by a quantity of credit tokens. In some embodiments, the balance may be increased by the quantity of credit tokens. These embodiments may include embodiments in which the user is purchasing a product or service from the provider of the digital content using the quantity of credit tokens. In other embodiments, the balance may be decreased by the quantity of credit tokens. These other embodiments may include embodiments in which the user is being rewarded by the provider of the digital content for the input provided by the user. The reward may be akin to paying the user for watching television.

In step 210, a balance of the user's credit tokens account is adjusted by a quantity of credit tokens. In one embodiment, the user credit tokens account may be adjusted to reflect the quantity of credit tokens added to a prior balance. In another embodiment, the user credit tokens account may be adjusted to reflect the quantity of credit tokens subtracted from the prior balance.

In a first example based on the method 200, the user may earn credit tokens by viewing an advertisement. In step 202, the digital content provided to the user's client device may include the advertisement. In step 204, the data received from the client device may include feedback or other data provided by the user regarding the advertisement. The entertainment system, for example application server 150, may use the feedback as a way to prevent deceptive transmission of data (e.g., automatically transmitted data masquerading as input from a user for the purpose of “gaming” the entertainment system) from being rewarded as legitimate input from the user in step 204. The feedback may include a simple acknowledgement that the advertisement was viewed, or a response to a quiz or survey concerning the advertisement. In other embodiments, the feedback may include a rating of the advertisement. In still other embodiments, the feedback may include a request for further information regarding the product or service advertised. In some embodiments, the feedback may include a request to initiate a purchase of the advertised product or service.

The feedback from the user may be processed and/or reported to a provider of the advertisement in close to real time to facilitate near-real-time monitoring of a promotion associated with the advertisement. In various embodiments, the near-real-time monitoring may be updated less than every second, every minute, every hour, or every day. In some embodiments, the feedback from the user may be aggregated with feedback from other users for monitoring purposes. The aggregation may be processed according to demographics, geography, user preferences, or other factors associated with the users providing the feedback. The near-real-time monitoring may facilitate the provider of the advertisement and/or entertainment system operator to manage a campaign or promotion associated with the advertisement in near-real-time. For example, advertisements which receive higher ratings may be presented to users more frequently than advertisements which receive lower ratings. In some embodiments, a recommended playlist of advertisements may be associated with a user, and advertisements which received higher ratings may be played earlier or placed higher in the recommended playlist than other advertisements.

In some embodiments, a user may configure a playlist of multiple individual elements of digital content, such as advertisements, to be played in continuous succession. In these embodiments, the user may earn credit tokens continuously throughout the playing of the digital content in the playlist without providing feedback between viewing of each of the individual elements of digital content. The playlist may be saved and played repeatedly, or shared with another user of the entertainment system. A user may earn credit tokens when the other user of the entertainment system with whom the playlist is shared views the playlist.

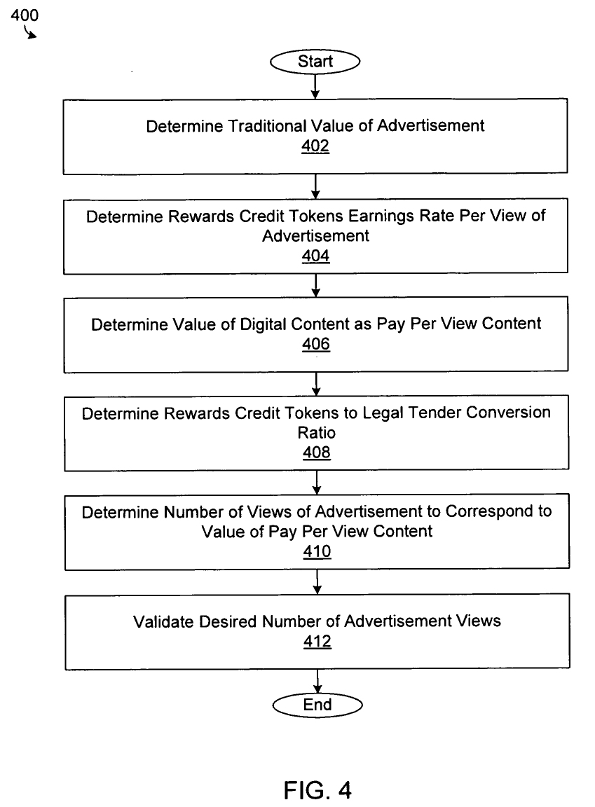

In step 206, a value associated with the feedback from the user may be determined. The value may be computed using calculation methods described below with respect to FIG. 4. In optional step 208, the balance of a credit tokens account associated with the provider of the digital content, the provider of the advertisement, or the entertain system operator may be reduced by a quantity of credit tokens according to the value computed in step 206. This optional step 208 may be performed, for example, if a limited quantity of credit tokens were allocated to be associated with the viewing of the advertisement. Step 208 may be performed as part of an accounting strategy for the credit tokens associated with the viewing of the advertisement. In step 210, the balance of the user's credit tokens account may be increased by the quantity of credit tokens according to the value computed in step 206. In some embodiments, the balance of the user's credit tokens account may only be increased after the advertisement has been verified as having been viewed completely. In other embodiments, the balance may be increased after the advertisement has been completely transmitted without verification that the user has actually viewed the advertisement. In still other embodiments, the balance may be increased after the user has agreed to view the advertisement, but the advertisement has not yet been transmitted to the user.

In a second example associated with method 200, the user may make a purchase transaction while viewing an entertainment program or an advertisement. In step 202, the digital content provided to the user's client device may include the entertainment program or advertisement. In step 204, the data received from the client device may include an indication that the user desires to make a purchase transaction. The user may do so by interacting with the client device by selecting an option to make a purchase from a menu, by pressing a “buy now” button on a remote control coupled with the client device, or other interaction with an I/O interface of the client device. The entertainment system may then pause playback of the entertainment program or advertisement to present an offer for one or more products or services related to the entertainment program or advertisement.

In step 206, a value of the selected product or service in terms of the user's credit tokens may be determined. The value may be computed using calculation methods described elsewhere herein with respect to FIG. 4. If the value computed exceeds the available credit tokens in the user's credit tokens account, or if the user prefers not to spend available credit tokens, a value of the product or service in terms of legal tender may be computed. The user may be given an option to purchase the product or service using the user's available credit tokens, legal tender, or a combination thereof. In optional step 208, the account balance associated with the product or service provider or the entertain system operator may be increased by a according to the value computed in step 206. If the product or service is purchased using legal tender in addition to or in place of credit tokens, an account denominated in legal tender associated with the provider of the product or service may be credited according to the value computed in step 206. The optional step 208 may be performed as part of an accounting strategy for the credit tokens associated with the purchase of the product or service. In step 210, the balance of the user's credit tokens account may be decreased by the quantity of credit tokens according to the value computed in step 206.

In a third example illustrating the method 200, the user may “tag” or otherwise provide input associated with selected content while viewing an entertainment program or an advertisement. In step 202, the digital content provided to the user's client device may include the entertainment program or advertisement. In step 204, the data received from the client device may include an indication that the user desires to tag the digital content. Tagging the digital content may include instructing the entertainment system to make an entry in a database (e.g., a favorites list, bookmarks list, etc.) which categorizes the digital content into one or more categories, associates a keyword with the digital content, or associates a text string such as a name or comment with the digital content. The user may do so by interacting with the client device by selecting an option to tag the digital content from a menu, by pressing a designated button on a remote control coupled with the client device, or other interaction with an I/O interface of the client device. Application server 150 may then implement a pause during playback of the entertainment program or advertisement to present an interface to facilitate tagging the entertainment program or advertisement.

In step 206, the value of tagging the digital content in terms of the user's credit tokens may be determined. The provider of the digital content or the entertainment system operator may reward the user for tagging the digital content according to the value. The value may be computed using calculation methods described elsewhere herein with respect to FIG. 4. In optional step 208, the balance of a credit tokens account for the entertainment program or advertisement provider or the entertainment system operator may be decreased according to the credit token value computed in step 206. The optional step 208 may be performed as part of an accounting strategy for the credit tokens associated with tagging the entertainment program or advertisement. In step 210, the balance of the user's credit tokens account may be increased by the quantity of credit tokens according to the value computed in step 206.

In some embodiments, tagging of the digital content in the third example above may be substituted with rating the digital content. Rating the digital content may include rating an advertisement or rating an entertainment program. A provider of digital content or the entertainment system operator may reward a user for rating the digital content to encourage the user to provide feedback on the digital content via ratings. Providers of digital content such as entertainment programs or advertisements may then be provided with ratings from users of the entertainment system in aggregate form, broken down by demographics or geography, or statistically correlated with other digital content.

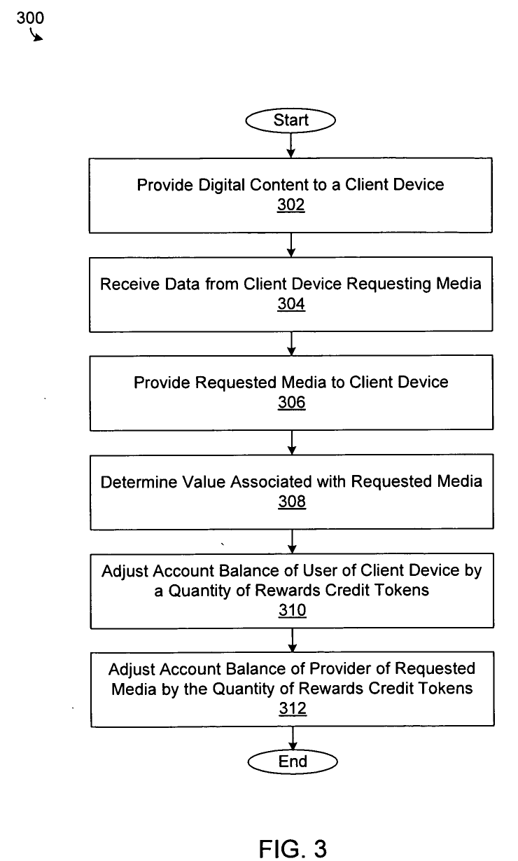

FIG. 3 illustrates an exemplary method 300 for rewarding a user of an entertainment system using digital media. The method may be performed by hardware and software contained in application server 150 and network server 145, and optionally servers 147, 160, 170, 180 and 190. In the method 300, the user may spend credit tokens to purchase a pay-per-view entertainment program. The user may use client device 110 to interact with application server 150 over a network such as the network 140.

In step 302, digital content is provided to a client device. The digital content may be provided by the application server 150, the media server 160, or another digital content provider 112 over the network 140. The digital content may include an entertainment program, an advertisement, a list of available entertainment programs from which the user may choose, or other data. For example, the digital content provided to the user's client device may include a listing of available pay-per-view programs from which the user may choose.

In step 304, data is received from the client device by application server 150. The data may represent input from the user requesting media. For example, the data may include a representation of the user pressing a “buy now” or other button on a remote control coupled with the client device, selecting an option from a menu of the client device, etc. The data received from the client device may include the user's choice of available pay-per-view programs.

In step 306, the media requested in step 304 is provided to the client device. The media provided may include a pay-per-view entertainment program. The media may also include an advertisement. The media may be provided with digital rights to view the requested media a set or unlimited number of times, digital rights to view the requested media over a fixed or unlimited period of time, or other digital rights associated with the media.

In step 308, a value associated with the media provided in step 306 is determined. The value may be determined according to method 400 described herein. The value may be denominated in terms of legal tender such as U.S. dollars or in credit tokens. The value may be determined to reward the user for providing the input. For example, if the user selected a pay-per-view program, the value of the pay-per-view program in terms of the user's credit tokens may be determined. If the value computed of the pay-per-view program exceeds the available credit tokens in the user's credit tokens account, a value of the pay-per-view program in terms of legal tender may be computed. The user may be given an option to purchase the pay-per-view program using the user's available credit tokens, legal tender, or a combination thereof.

In step 310, a balance of a user account associated with the user of the client device may be adjusted by a quantity of credit tokens. In some embodiments, the balance may be increased by a quantity of credit tokens. A user account balance may be increased when the user is being rewarded by the media provider for requesting and receiving the media. In other embodiments, the balance may be decreased by the quantity of credit tokens. An account balance decrease may occur when the user is purchasing a product or service from the provider of the media using the quantity of credit tokens. In step 312, if the user selected a pay-per-view content, the balance of a credit tokens account associated with the provider of the pay-per-view content or the entertain system operator may be increased by the quantity of credit tokens. If the pay-per-view program is purchased using legal tender in addition to or in place of credit tokens, an account denominated in legal tender associated with the provider of the pay-per-view content may be credited. Step 312 may be performed as part of an accounting strategy for the credit tokens associated with the viewing of the pay-per-view program.

In some embodiments, the pay-per-view entertainment program purchased may be substituted with rights to view an entertainment program a set number of times over a fixed period of time, an unlimited number of times over a fixed period of time, or without any time or view count restraints. In some embodiments, the pay-per-view entertainment program purchased may be substituted with physical products or services offered by third parties. These third parties may be associated with one or more third party servers 110 configured to conduct financial transactions in communication with the application server 150.

FIG. 4 illustrates an exemplary method for determining reward values associated with advertisements. The method of FIG. 4 may be performed by application server 150. In some embodiments, advertisements may be uniformly valued such that a user earns a same number of credit tokens as a reward for viewing each advertisement (i.e., credit tokens earning rate), either on an advertisement by advertisement basis or on a per unit time of viewing an advertisement basis. In other embodiments, each advertisement may be assigned a unique value or credit tokens earning rate based on a variety of factors. The factors may include digital content such as entertainment programs associated with or viewed in proximity to the advertisement, popularity of the advertisement, payments made by the provider of the advertisement to the entertainment system operator, promotions associated with the advertisement, and other factors as may be known to those skilled in the art of advertising. The credit tokens earnings ratio of a given advertisement may be fixed to be within a range of approximately one to six percent of legal tender revenue (e.g., gross or net of costs associated with transmitting the advertisement) collected by the entertainment system operator associated with distributing or transmitting the advertisement. The earnings ratio may be adjusted by the entertainment system operator and/or the advertiser periodically or dynamically.

In step 402, a traditional value of an advertisement is determined. The traditional value may represent the value of the advertisement if aired on traditional broadcast, cable, or satellite television. The traditional value of the advertisement may be represented as a cost per thousand views, or CPM. In some embodiments, the CPM may be at least partially dependent on the genre of the entertainment program viewed by the user in proximity to viewing the advertisement. For example, the genre may include movies, children's entertainment, sports, news programs, documentaries, miscellaneous entertainment, and other programming. The CPM may also be at least partially dependent on the popularity and/or viewer demand for the entertainment program viewed by the user in proximity to viewing the advertisement (e.g., new episode of a very popular program, new episode of an average demand program, syndicated program, repeat episode, etc.). The CPM may additionally be at least partially dependent on the number of advertisement minutes allocated per hour of entertainment program viewed by the user in proximity to advertisements.

Based on the CPM, a traditional gross legal tender revenue generated per hour of entertainment programming (gross revenue) per viewer supported by the advertisement may be computed. The gross revenue per viewer may be at least partially dependent on a number of times the advertisement is viewed in the hour of entertainment programming. For example, the gross revenue per viewer may be based on 24 advertisement viewings per hour assuming a 30 second advertisement duration, 12 minutes of paid advertisement programming per hour, and 48 minutes of entertainment programming per hour. As another example, the gross revenue per viewer may be based on 30 advertisement viewings per hour assuming a 30 second advertisement duration, 15 minutes of paid advertisement programming per hour, and 45 minutes of entertainment programming per hour. In some embodiments, the gross revenue per viewer may be averaged across all genres of programming, either uniformly or according to a weighting factor.

In step 404, the credit tokens earning rate per view of the advertisement is determined. The credit tokens earning rate may be computed according to a factor which may typically vary between approximately one percent and six percent of gross revenue per viewer generated by the advertisement as determined in step 402. A credit tokens earning rate factor averaged over all advertisements may typically vary between approximately one and two percent. In some embodiments, the credit tokens earning rate may be provisionally computed in terms of legal tender to be later converted into a quantity of credit tokens earning rate based on a conversion rate to be determined. For example, the gross revenue per viewer of an advertisement computed in step 402 may be multiplied by a factor of one percent to arrive at a legal tender value of credit tokens earning rate for the advertisement. Thus, if the gross revenue per viewer computed in step 402 is $2.50 per hour, the legal tender value of credit tokens earning rate based on a one percent factor may be $0.025. Likewise, the legal tender value of credit tokens earning rate based on a two percent factor may be $0.05.

In step 406, a value of digital content as pay-per-view content is determined. The value may be determined in terms of legal tender and may be at least partially dependent upon market forces and economic environment. The digital content may include an entertainment program of a given genre and demand, as described above with respect to step 402. The pay-per-view digital content may include episodes of entertainment programs, children's programming, music, movies, sports events, and other pay-per-view content provided by cable and satellite television operators. For example, a pay-per-view movie may be valued at $3.99 per view, while an episode of a television entertainment program may be valued at $0.99 per view.

In step 408, a credit tokens to legal tender conversion ratio is determined. The conversion ratio may be determined arbitrarily, or according to market forces if credit tokens are exchangeable for legal tender through the entertainment system operator or through a third party. For example, the conversion ratio may be determined to be 20 credit tokens or 40 credit tokens per US dollar. Using the conversion ratio, a quantity of credit tokens required to view pay-per-view content given a value of the pay-per-view content as determined in step 406 may be computed. For example, a pay-per-view program valued at $3.99 per view may require approximately 80 credit tokens at a 20 credit tokens per U.S. dollar conversion ratio. Likewise, at a 40 credit token per U.S. dollar conversion ratio, a pay-per-view program valued at $3.99 per view may require approximately 160 credit tokens.

In step 410, a number of views of an advertisement to correspond to a value of a pay-per-view content are determined. In an embodiment, the value of the pay-per-view content determined in step 406 may be divided by the legal tender value of credit tokens earning rate of an advertisement determined in step 404. For example, a pay-per-view program valued at $3.99 may require approximately 80 views of an advertisement with a legal tender value of credit tokens earning rate of $0.05 per view. At a conversion rate of 40 tokens per U.S. dollar, an advertisement with a legal tender value of credit tokens earning rate of $0.05 per view would have a quantity of credit tokens earning rate of 2 credit tokens per view.

In step 412, the desired number of advertisement views are validated. A desired number of advertisement views for a given pay-per-view program is multiplied by a desired quantity of credit tokens earning rate to determine a quantity of credit tokens desired to equal the value of the pay-per-program determined in step 406. The quantity of credit tokens desired to equal the value of the pay-per-view program is then multiplied by the desired conversion ratio to determine a legal tender advertisement revenue. The legal tender advertisement revenue is then compared to the value of the pay-per-view program determined in step 406. If the legal tender advertisement revenue meets or exceeds the value of the pay-per-view program, the method may end. Otherwise, variables such as the percentage factor, the conversion ratio, and the desired number of advertisement views may be adjusted until the legal tender advertisement revenue meets or exceeds the value of the pay-per-view program. For example, a desired number of advertisement views of 39 per hour of digital content may be multiplied by an average advertisement's CPM of $93 and divided by 1,000 to obtain the revenue generated by the desired number of advertisement views. The revenue generated by watching the desired number of advertisements is then compared to an average pay-per-view program value per hour of $2.50. When the revenue generated exceeds the pay-per-view program value of $2.50 per hour, validation is complete.

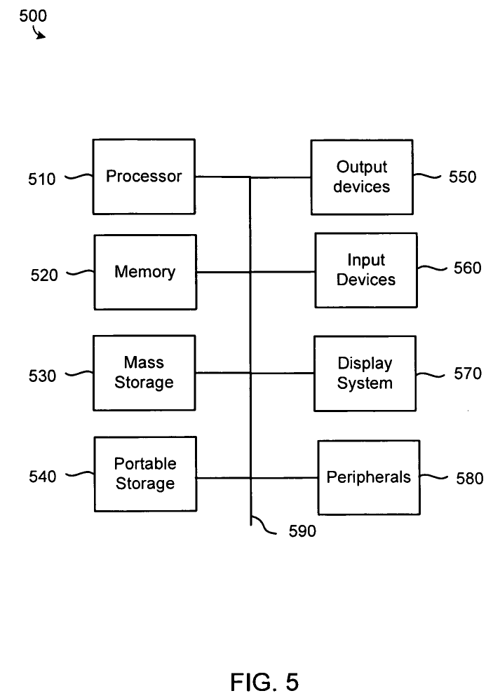

FIG. 5 is a block diagram of an exemplary device for implementing computing devices in an interactive media service environment. In some embodiments, the exemplary computing device of FIG. 5 may be used to implement client 104 and client devices 110, 120, and 130, network server 145, stream content server 147, application server 150, media server 160, ad server 170, user data store 180, and third party server 190.

The computing system 500 of FIG. 5 includes one or more processors 510 and memory 520. Main memory 520 stores, in part, instructions and data for execution by processor 510. Main memory 520 may store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 may store the system software for implementing embodiments of the present invention for purposes of loading that software into main memory 520.

Portable storage device 540 operates in conjunction with a portable non-volatile storage medium, such as a floppy disk, compact disc (CD), digital versatile disc (DVD), flash memory card or stick, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a CRT, a liquid crystal display (LCD) or other suitable display device. Display system 570 receives textual and graphical information, and processes the information for output to the display device. Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 may be a personal computer, hand held computing device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows, Macintosh OS, Palm OS, and other suitable operating systems.

The embodiments discussed herein are illustrative. As these embodiments are described with reference to illustrations, various modifications or adaptations of the methods and/or specific structures described may become apparent to those skilled in the art.

The above-described modules may be comprised of instructions that are stored on storage media (e.g., computer readable storage media). The instructions may be retrieved and executed by a processor (e.g., the processor 510). Some examples of instructions include software, program code, and firmware. Some examples of storage media comprise memory devices and integrated circuits. The instructions are operational when executed by the processor to direct the processor to operate in accordance with embodiments of the present invention. Those skilled in the art are familiar with instructions, processor(s), and storage media.

In the foregoing specification, the invention is described with reference to specific embodiments thereof, but those skilled in the art will recognize that the invention is not limited thereto. Various features and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A computer-implemented method for rewarding a user of an entertainment system comprising:
providing digital content to a client device over a network by a server;
receiving data from the client device over the network by the server, the data representing an input from a user of the client device in response to the digital content provided to the client device;
determining a value by the server, the value associated with the input from the user; and
adjusting an account balance associated with the user by a quantity of credit tokens, the quantity of credit tokens determined by the value associated with the input from the user.

2. The computer-implemented method of claim 1, further comprising adding the quantity of credit tokens to an account associated with a provider of the digital content provided to the client device.

3. The computer-implemented method of claim 1, further comprising withdrawing the quantity of credit tokens from an account associated with a provider of the digital content provided to the client device.

4. The computer-implemented method of claim 1, wherein the digital content comprises an advertisement for a product or service.

5. The computer-implemented method of claim 1, wherein the data comprises a rating of the digital content.

6. The computer-implemented method of claim 1, wherein the data comprises a selection upon which a choice of an advertisement to be sent to the client device is based.

7. The computer-implemented method of claim 1, wherein the data comprises a purchase of a product or service associated with the digital content provided to the client device.

8. The computer-implemented method of claim 1, wherein the data comprises a response to a query presented to the user within the digital content provided to the client device.

9. The computer-implemented method of claim 1, wherein the credit tokens may be exchanged for legal tender upon receipt of instructions to do so from the user over the network.

10. The computer-implemented method of claim 1, wherein the credit tokens may be transferred to another user's account upon receipt of instructions to do so from the user over the network.

11. The computer-implemented method of claim 1, wherein the credit tokens may be exchanged for a product or service associated with the digital content provided to the client device.

12. The computer-implemented method of claim 1, wherein the data comprises a request for media, and further comprising:
providing the requested media to the client device over the network in response to the request;
determining a value associated with the requested media;
adjusting an account balance associated with a provider of the requested media by a quantity of credit tokens, the quantity of credit tokens determined by the value associated with the requested media.

13. The computer-implemented method of claim 12, wherein the requested media comprises an advertisement for a product or service and the provider of the requested media is associated with the advertised product or service.

14. The computer-implemented method of claim 13, wherein one or more of the quantity of credit tokens may be exchanged for improved presentation of the advertisement to the user.

15. The computer-implemented method of claim 12, wherein the quantity of credit tokens is withdrawn from the account associated with the user.

16. A computer readable storage medium having stored thereon a program executable by a processor to perform a method for rewarding a user of an entertainment system, the method comprising:
providing digital content to a client device over a network;
receiving data from the client device over the network, the data representing an input from a user of the client device in response to the digital content provided to the client device;
determining a value associated with the input from the user; and
adjusting an account balance associated with the user by a quantity of credit tokens, the quantity of credit tokens determined by the value associated with the input from the user.

17. The computer readable storage medium of claim 16, wherein the credit tokens have properties specifying their value, how they may be earned, how they may be exchanged, or how long they may be valid.

18. The computer readable storage medium of claim 16, wherein the method further comprises limiting a quantity of credit tokens which may exist at a given time.

19. The computer readable storage medium of claim 16, wherein the data comprises a referral of the digital content to a friend of the user of the client device, the friend being another user of the entertainment system having a separate account from the user of the client device.

20. The computer readable storage medium of claim 16, wherein the credit tokens may be exchanged for third party rewards program points upon receipt of instructions to do so from the user over the network.

21. The computer readable storage medium of claim 16, wherein the credit tokens may be among a fixed quantity of credit tokens having properties which limit their exchange, the fixed quantity of credit tokens being associated with the digital content.

22. The computer readable storage medium of claim 16, wherein the credit tokens may be among a fixed quantity of credit tokens having properties which limit their exchange, the fixed quantity of credit tokens being associated with the data.

23. The computer readable storage medium of claim 16, wherein the data comprises a tag to be applied to the digital content.

24. The computer readable storage medium of claim 16, further comprising receiving a request from the user for further information relating to the digital content and providing an interactive survey to the user via the client device, and wherein the data comprises a response to the interactive survey from the user.

25. The computer readable storage medium of claim 16, further comprising receiving a request from the user to interact with the digital content and providing additional interactive digital content to the user via the client device, and wherein the data comprises a response to the additional interactive digital content from the user.

26. The computer readable storage medium of claim 16, wherein the data comprises a purchase of a bundled package comprising one or more products or services associated with the digital content provided to the client device.

27. The computer readable storage medium of claim 16, wherein the digital content comprises an advertisement for a product or service, and the value associated with the input from the user is determined by performing a method comprising:
determining a traditional value of the advertisement for free digital content;
determining a value of the digital content as pay per view content;
determining a revenue generated per view of the advertisement;
determine a number of views of advertisements to correspond to the value of the digital content as pay per view content; and
determining a credit tokens earnings value per view of the advertisement based on at least the value of the digital content as pay per view content, the number of advertisements determined to correspond to the value of the digital content as pay per view content, and the revenue generated per view of the advertisement.

28. A computer-implemented method for rewarding a user of an entertainment system comprising:
providing electronic media by a server to a client device associated with a user over a network;
receiving user data by the server from the client device over the network, the user data associated with a user action related to the electronic media provided to the client device;
determining a reward for the user by the server, the reward determined at least in part from the user data; and
adjusting an account balance associated with the user based on the reward.

29. The computer-implemented method of claim 28, further comprising:
receiving a media request from the client device, the electronic media provided in response to the media request;
adjusting an account balance associated with a provider of the electronic media by a quantity of credit tokens, the quantity of credit tokens determined by a value associated with the electronic media.

30. The computer-implemented method of claim 28, wherein the electronic media comprises an advertisement for a product or service and a provider of the electronic media is associated with the advertised product or service.
